(19) United States
(12) Patent Application Publication
(10) Pub. No.: US 2009/0000233 A1
(43) Pub. Date: Jan. 1, 2009

(54) WALL BLOCK AND APPARATUS AND METHOD FOR MAKING THE SAME

(75) Inventor: James Hammer, University Place, WA (US)

Correspondence Address: KLARQUIST SPARKMAN, LLP, 121 SW SALMON STREET, SUITE 1600, PORTLAND, OR, 97204, US

(73) Assignee: Westblock Systems, Inc.

(21) Appl. No.: 12/205,784

(22) Filed: Sep. 5, 2008

Related U.S. Application Data
(63) Continuation-in-part of application No. 11/825,485, filed on Jul. 6, 2007.
(60) Provisional application No. 60/967,802, filed on Sep. 7, 2007.
(60) Provisional application No. 60/897,027, filed on Jan. 22, 2007.

(51) Int. Cl. E04C 1/00; B29C 33/42

(52) U.S. Cl. 52/596; 249/140

(57) ABSTRACT

According to one aspect, the present disclosure concerns embodiments of an apparatus and method for making a wall block, such as for constructing retaining walls or fences, that has at least one surface formed with a pattern resembling the faces of multiple blocks. In particular embodiments, the surface of the wall block has a plurality of discrete surface portions that are separated by one or more vertically elongated recessed surface portions or scores such that each surface portion resembles the face of a separate block. At least one surface portion of a block is offset from another surface portion of the block in a direction perpendicular to the plane of the wall. The surface portions can be provided with roughened surface textures resembling the surface of a split block, which can be formed by roughening or texturing the uncured block as it is removed from a mold.

### CROSS-REFERENCE TO RELATED APPLICATIONS

The present application claims the benefit of U.S. Provisional Application No. 60/967,802, filed Sep. 7, 2007, which is incorporated herein by reference. The present application is also a continuation-in-part of U.S. application Ser. No. 11/825,485, filed Jul. 6, 2007, which claims the benefit of U.S. Provisional Application No. 60/897,027, filed Jan. 22, 2007. U.S. application Ser. Nos. 11/825,485 and 60/897,027 are incorporated herein by reference.

### FIELD

The present disclosure concerns embodiments of an apparatus and method for making a wall block, such as for constructing retaining walls or fences.

### BACKGROUND

Masonry products, such as blocks or bricks for constructing walls, have been made for many years by various molding processes. It is common to split off a portion of a cured block, such as with a splitting machine or a hammer and chisel, so as to create a decorative face on a surface of the block that resembles the surface texture of natural stone. The face created by the splitting process is often referred to in the industry as “split face” or “rock face.” Blocks formed with a split face are highly appealing for constructing retaining walls and fences. The splitting of cured blocks, however, involves additional equipment and manufacturing steps and results in material wastage.

In order to avoid the shortcomings of conventional splitting processes, a number of techniques have been developed to achieve the same “split face” texture without additional splitting steps. For example, U.S. Pat. No. 7,100,866 to Hammer et al. discloses a mold having a series of inwardly extending projections that contact an adjacent surface of an uncured block in the mold. As the uncured block is stripped from the mold, the projections create a roughened or irregular surface texture on the adjacent block surface resembling a “split face.”

It is also desirable to create an “ashlar” or random pattern in the exposed face of a retaining wall or fence to provide the appearance of a wall made from natural stone blocks. Various block systems have been proposed to create an ashlar pattern in a wall. These block systems typically comprise multiple blocks of different sizes that can be randomly stacked together in a wall. Another technique used to form an ashlar pattern involves stamping or molding into the surface of an uncured block a pattern that resembles the faces of multiple, differently sized blocks. This allows construction of a wall having an ashlar pattern using multiple blocks of the same size and shape.

### SUMMARY

According to one aspect, the present disclosure concerns embodiments of a wall block, and apparatus and method for making a wall block, such as for constructing retaining walls or fences, that has at least one face or surface formed with a pattern resembling the faces of multiple blocks. In particular embodiments, the surface of the wall block has a plurality of discrete surface portions that are separated by one or more elongated recessed surface portions or scores such that each surface portion resembles the face of a separate block. The surface portions can be provided with roughened surface textures resembling the surface of a split block, which can be formed by roughening or texturing the uncured block as it is removed from a mold. Instead of recessed surface portions separating the surface portions on a block face, the block face can be formed with a flat, non-roughened elongated surface portion that extends between and separates two surface portions on the block face.

The surface portions desirably are different sizes so that a wall constructed from multiple blocks of the same size has the appearance of being constructed from multiple blocks of different sizes. The surface portions include at least first and second surface portions that are offset relative to each other in a direction perpendicular to the block surface. In other words, one surface portion extends outwardly a greater distance than the other surface portion. The offset surface portions enhance the visual appearance of a wall constructed from multiple blocks by creating a shadowing effect on the surface of the wall and by creating the appearance of a random block pattern in the wall, mimicking a wall constructed from natural stone. The surface portions can be positioned side-by-side or one above the other on the block face. Where the block face is formed with more than two surface portions, the surface portions can be positioned side-by-side and/or one above the other on the block face.

The roughened surface texture on the surface portions can be produced by forming the block in a mold having a mold wall including a plurality of projections extending into the mold cavity and contacting an adjacent surface of the block. The projections are arranged in sets of projections for forming the discrete surface portions on the surface of the block. The projections are configured such that as an uncured block is removed from the mold, the projections move across the adjacent surface of the block and create a roughened surface texture on each surface portion on the block. To create an offset between the surface portions, one set of projections is offset inwardly in a direction perpendicular to the inside surface of the mold wall relative to another set of projections to form two offset surface portions in the face of the block. The mold wall can include an elongated bar that extends between the sets of projections and is effective to create a notch or score on the block face between the surface portions. Alternatively, the inside surface of the mold wall can have a flat surface portion that extends between two sets of projections on the mold wall so as to form a corresponding flat, non-roughened surface portion extending between and separating two roughened surface portions on the block face.

According to one representative embodiment, an apparatus for molding and forming a roughened surface texture on at least one face of an uncured masonry block comprises a mold defining at least one mold cavity. The mold comprises a first opening through which block-forming material is introduced into the mold cavity, and a second opening through which a formed, uncured block may be removed from the mold cavity. The mold further comprises at least one wall having a plurality of projections extending into the mold cavity and contacting an adjacent face of the uncured block, such that when the uncured block is removed from the mold cavity, the projections create a roughened surface texture on at least a first surface portion and a second surface portion of the adjacent face. The at least one wall is also configured to form the first and second surface portions such that the first surface portion is offset relative to the second surface portion in a direction perpendicular to the adjacent face.

According to another representative embodiment, a method for forming a masonry block comprises introducing block-forming material into a mold cavity of a mold and forming an uncured block in the mold. The mold has a plurality of projections that extend into the mold cavity and are located between the top and bottom of the mold cavity. The uncured block has an adjacent surface which is adjacent to the plurality of projections and comprises at least a first surface portion and a second surface portion that are offset relative to each other in a direction perpendicular to the adjacent surface. The method further includes removing the uncured block from the mold cavity to move the projections across the first surface portion and the second surface portion so as to give a roughened appearance to the first surface portion and the second surface portion.

According to yet another representative embodiment, a masonry block is formed by a method comprising introducing block forming material into a mold defining at least one mold cavity and forming an uncured block in the mold cavity. The mold cavity has a first opening through which the block-forming material is introduced into the mold cavity, and a second opening through which the uncured block may be removed from the mold cavity. The mold also has a plurality of projections extending into the mold cavity. The uncured block has a surface adjacent to the plurality of projections and comprises at least a first surface portion and a second surface portion that are non-coplanar with respect to each other. The method further comprises removing the uncured block from the mold cavity to move the projections across the first surface portion and the second surface portions to create a roughened surface texture on each of the first and second surface portions.

The foregoing and other features and advantages of the invention will become more apparent from the following detailed description, which proceeds with reference to the accompanying figures.

### BRIEF DESCRIPTION OF THE DRAWINGS

FIG. 1 is a perspective view of an exemplary embodiment of a wall block having two opposing surfaces (one of which is shown in FIG. 1), one of which is formed with three roughened surface portions giving the appearance of three separate block faces, and the other of which is formed with two roughened surface portions giving the appearance of two separate block faces.

FIG. 2 is a top plan view of the block of FIG. 1.

FIG. 3 is a front elevation view of an exemplary embodiment of a mold wall configured to form three roughened surface portions on the surface of an uncured block formed in a mold.

FIG. 4 is a top plan view of the mold wall in FIG. 3.

FIG. 5 is a cross-sectional view of the mold wall taken along line 5-5 in FIG. 3.

FIG. 6 is a schematic, cross-sectional view of an exemplary embodiment of a mold for forming multiple blocks of the type shown in FIG. 1.

FIG. 7 is a schematic, cross-sectional view of the mold of FIG. 6 showing a plurality of formed, uncured blocks being removed from the mold.

FIG. 8 is a schematic, top plan view of the mold shown in FIG. 6.

FIG. 9 is a perspective view of another embodiment of a wall block having plural roughened surface portions in each face of the block.

FIG. 10 is a top plan view of the block of FIG. 9.

FIG. 11 is a front elevation view of an exemplary embodiment of a mold wall of a mold that can be used to form the block of FIG. 9.

FIG. 12 is a top plan view of the mold wall of FIG. 11.

FIG. 13 is a cross-sectional view of the mold wall taken along line 13-13 of FIG. 11.

FIG. 14 is a perspective view of another embodiment of a wall block having plural roughened surface portions in each face of the block.

FIG. 15 is a front elevation view of the block of FIG. 14.

FIG. 16 is a side elevation view of the block of FIG. 14.

FIG. 17 is a top plan view of the block of FIG. 14.

FIG. 18 is a front elevation view of an exemplary embodiment of a mold wall of a mold that can be used to form the block of FIG. 14.

FIG. 19 is a cross-sectional view of the mold wall taken along line 19-19 of FIG. 18.

FIG. 20 is a cross-sectional view of the mold wall taken along line 20-20 of FIG. 18.

### DETAILED DESCRIPTION

As used herein, the singular forms “a,” “an,” and “the” refer to one or more than one, unless the context clearly dictates otherwise.

As used herein, the term “includes” means “comprises.” For example, a device that includes or comprises A and B contains A and B but may optionally contain C or other components other than A and B. A device that includes or comprises A or B may contain A or B or A and B, and optionally one or more other components such as C.

As used herein, the term “ashlar pattern” refers to a pattern of differently sized block faces in the exposed surface of a wall or other structure constructed from multiple masonry blocks. The embodiments disclosed herein can be adapted to produce an ashlar pattern in at least one surface of a single block, so as to give the appearance of multiple block faces of different sizes.

As used herein, the term “masonry block” refers generally to any block that can be laid or stacked with other blocks to form a structure, such as a wall (e.g., a retaining wall or a fence), steps, or a structure providing a horizontal upper surface (e.g., a walkway or patio). A masonry block can have any geometric shape, including but not limited to a square, rectangle, trapezoid, diamond, or combinations thereof. The structures formed by masonry blocks need not utilize mortar to join adjacent blocks.

According to one aspect, the present disclosure concerns embodiments of an apparatus and method for making a masonry block having two or more roughened surface portions on the same surface of the block that are offset relative to each other to provide the appearance of two or more split faces of multiple blocks. In particular embodiments, the roughened surface portions are different sizes to create a random, or ashlar, pattern on one surface of the block. The embodiments described herein can be adapted to produce various types of masonry blocks, such as decorative architectural blocks, paving stones, landscaping blocks, retaining wall blocks, blocks for constructing fences or free-standing walls, steps, or walkways, and the like.

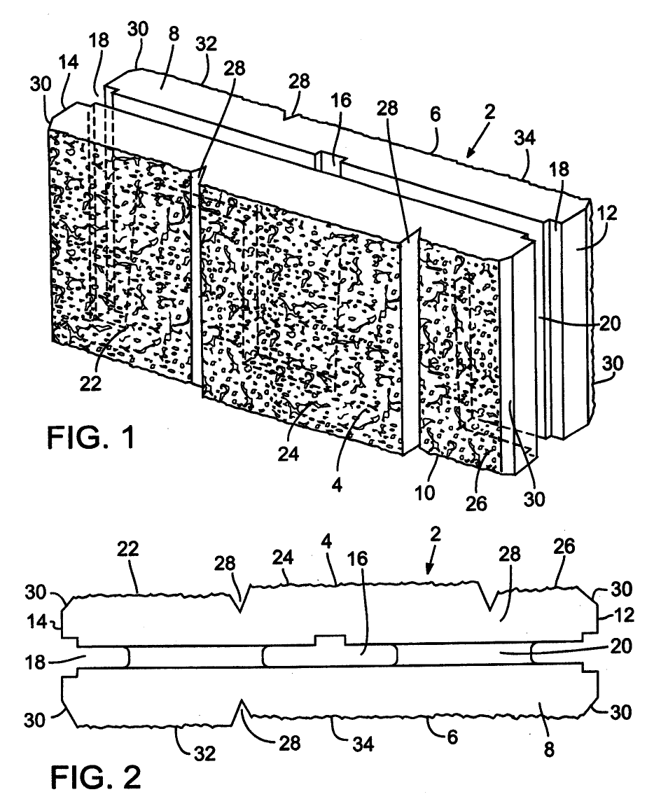

FIGS. 1 and 2 show a wall block 2, according to one embodiment, having first and second opposed faces 4, 6, respectively, a top surface 8, a bottom surface 10, and side surfaces 12, 14 extending between the first and second faces. The block 2 in the illustrated example is adapted to be used in constructing a free-standing wall or fence having two exposed wall surfaces. When constructing a wall from multiple blocks 2, the blocks 2 are placed in courses with the first faces 4 of the blocks exposed in one surface of the wall and the second faces 6 exposed in the opposite surface of the wall. The illustrated block 2 is “reversible” such that both surfaces of the wall can include a plurality of first faces 4 of multiple blocks 2 and a plurality of second faces 6 of multiple blocks 2. The block 2 can be formed with a centrally located vertical core 16, vertical cores 18 at opposite sides of the block, and a horizontally extending channel, or trough 20, opening at the sides 12, 14 and the top 8 of the block. The cores 16, 18 and channel 20 can be adapted to receive hardware for interconnecting multiple blocks in a wall, such as vertically and/or horizontally extending tensioning members or rebar.

The first face 4 has first, second, and third surface portions 22, 24, and 26, respectively, separated by vertical scores, or notches 28. The second surface portion 24 is offset, or non-coplanar with respect to the first surface portion 22 and the third surface portion 26. The second surface portion 24 is offset outwardly relative to surface portions 22 and 26 so that the second surface portion 24 projects outwardly a greater distance in the surface of a wall than surface portions 22 and 26. The second face 6 illustrates an alternative face configuration comprising a first surface portion 32 and a second surface portion 34 separated by a notch 28. The first surface portion 32 is offset (outwardly), or non-coplanar with respect to the second surface portion 34. The outer edges 30 of each of the faces 4, 6 can be slightly beveled or angled such that when multiple blocks are stacked end-to-end in respective courses of a wall, the edges 30 of two adjacent blocks abut each other form a notch that is similar to notches 28. The surface portions of each face 4, 6 desirably have a roughened surface texture resembling a split block. The offset surface portions 22, 24, 26 create a shadowing effect and contribute to providing a unique, random block pattern in the wall.

It will be understood that the description of three surface portions 22, 24, 26 in the first face 4 and two surface portions 32, 34 in the second face 6 are merely exemplary and either face could have any number of surface portions separated by a notch 28 or a flat, non-roughened surface portion. Additionally, in a face having more than two surface portions, at least two of the surface portions could be co-planar and offset from a third surface portion or combined in any alternative arrangement, and any one of the surface portions could be the same size as or a different size than any other of the surface portions.

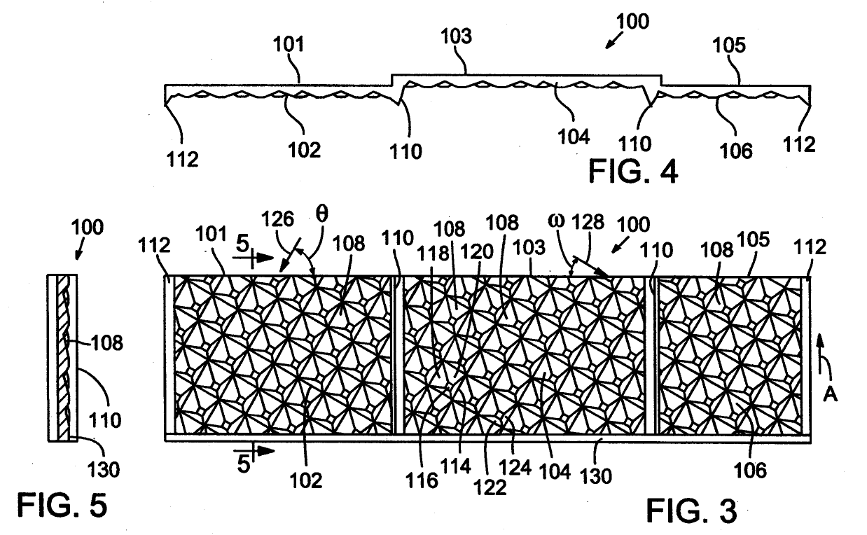

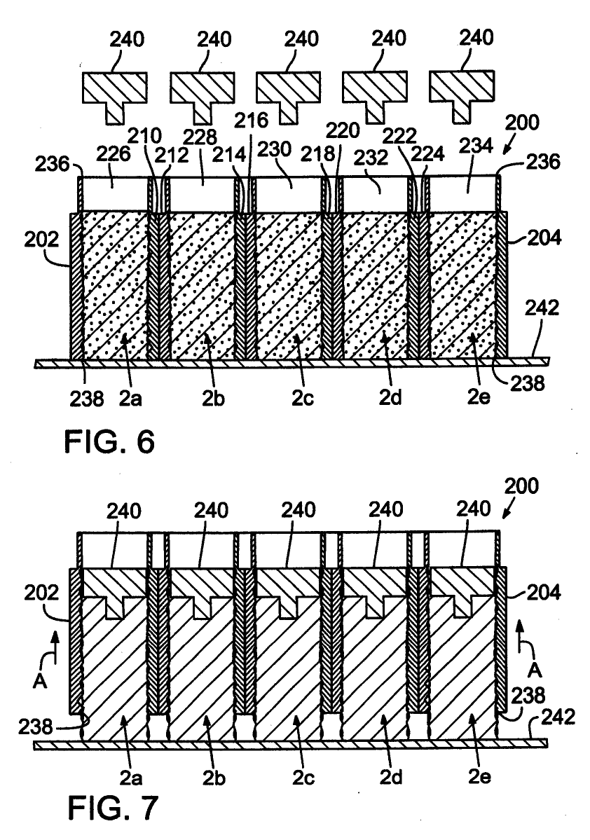

FIGS. 3-5 illustrate a mold wall designed to form the roughened surface texture on the surface portions 22, 24, 26 of the first face 4 of the masonry block shown in FIGS. 1 and 2, according to one embodiment. The mold wall 100 comprises a first wall portion 101 defining a first roughening surface 102, a second wall portion 103 defining a second roughening surface 104, and a third wall portion 105 defining a third roughening surface 106. As used herein, the “major surfaces” of the mold wall refer to the largest surfaces of the wall (the surfaces of the wall with the largest surface areas). A plurality of abutting block-texturing members, or projections, 108 extend outwardly from each of the roughening surfaces. As will be shown in greater detail in FIGS. 6-8, the projections 108 on each of the roughening surfaces 102, 104, 106 project outwardly from the inner surface of the mold wall and contact an adjacent surface portion 22, 24, 26 of the first face 4 of a masonry block 2. Thus, the first roughening surface 102 defines a first set of projections 108; the second roughening surface 104 defines a second set of projections 108, and the third roughening surface defines a third set of projections 108. As shown, the projections 108 of the first and third roughening surfaces are offset relative to the projections 108 of the second roughening surface and extend into the mold cavity a greater distance than the projections of the second roughening surface in order to create the offset surface portions 22, 24, 26 of the block. As the mold is moved vertically with respect to a block 2 in the direction of arrow A, the projections 108 produce a “scraping,” or “tearing,” action on the respective faces of the block, thereby creating an irregularly roughened surface for those sides of the block 2.

As shown in FIG. 3, the mold wall 100 can include an elongated vertical bar or projection 110 between the first roughening surface 102 and the second roughening surface 104, and an elongated vertical bar 110 between the second roughening surface 104 and the third roughening surface 106. The mold wall 100 can further include outer vertical bars or projections 112 on the outer edges of the first roughening surface 102 and the third roughening surface 106. The elongated vertical bars 110 protrude from the mold wall to form the notches 28 in the first face 4 or the second face 6 of a masonry block 2 as the mold is moved vertically with respect to the block. The outer vertical bars 112 form the angled outer edges 30 of the masonry block 2 as the mold wall 100 is moved with respect to the block.

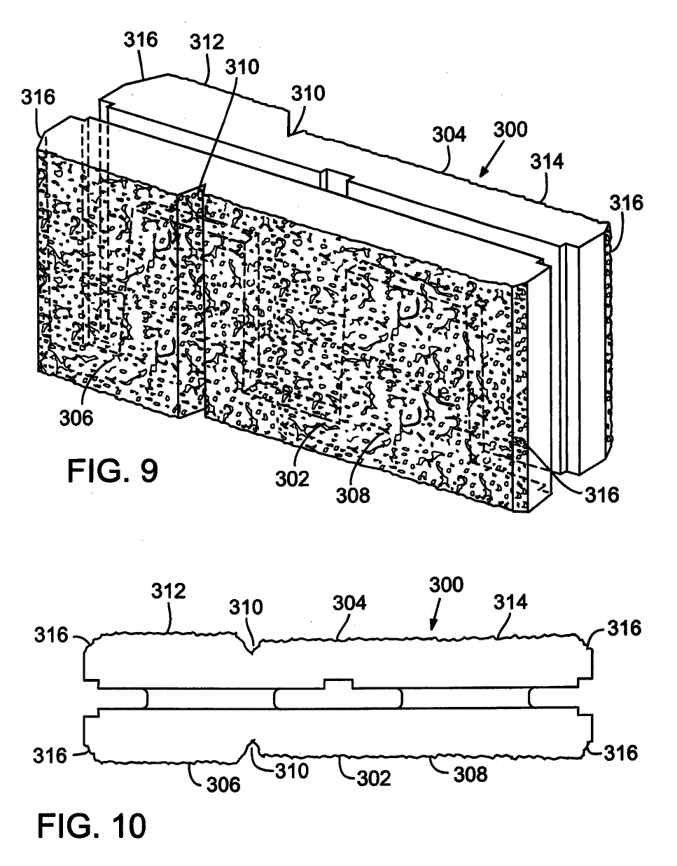

The projections 110, 112 can have flat, smooth surfaces to form notches 28 and edges 30 that have flat, relatively smooth (non-roughened) surfaces, as depicted in FIG. 1. Additionally, the projections 110, 112 do not necessarily need to have a “V” shaped cross-section as shown in FIG. 4, but could have a cross section of any other shape such as rounded, square, or trapezoidal. In alternative embodiments (such as shown in FIG. 9), the elongated vertical bars 110, 112 can be formed with projections similar to projections 108 to produce a “scraping,” or “tearing,” action on the surfaces of notches 28 and edges 30 to texture those surfaces of the block.

As shown in FIGS. 3-5, the projections 108 desirably taper as they extend outwardly from the respective roughening surfaces 102, 104, 106. In the illustrated embodiment, for example, each projection 108 is generally “frusto-pyramidal” in shape, that is, each projection 108 has a square-shaped base 114 at the mold surface, a flattened, square-shaped end surface or crest 116 spaced from the base 114, and four flat side surfaces 118, 120, 122, 124 that converge as they extend from the base 114 to the end surface 116. However, other tapered or non-tapered shapes may be used for the projections 108. For example, the projections 108 may be pyramidal, conical, frusto-conical, rectangular, square, cylindrical, or any of other various shapes.

Desirably, the projections 108 are distributed uniformly throughout the surface area of the first, second, and third roughening surfaces 102, 104, 106. As best shown in FIG. 3, the projections 108 in the illustrated embodiment are arranged side-by-side in diagonal rows extending across each of the roughening surfaces 102, 104, 106 without spacing between projections or between adjacent rows of projections, except for the elongated vertical bars 110. In other embodiments, the rows of projections 108 may extend horizontally to form a “checkerboard” pattern of projections. In addition, in other embodiments, the projections 108 may be spaced apart in the direction of the rows of projections. In still other embodiments, the rows of projections may be spaced apart from each other.

As shown in FIG. 3, and except for those projections bordering the elongated vertical bars 110 and the outer vertical bars 112, the base 114 of each projection 108 adjoins the base 114 of an adjacent projection to minimize spacing between the crests 116 of adjacent projections. The side surfaces 118, 120 of each projection 108 face in a generally upward direction and the side surfaces 122, 124 face in a generally downward direction. Thus, it can be seen that the side surfaces 122, 124, along with the end surface or crest 116 of each projection 108 produce the scraping action against the adjacent surface of the block 2 as the mold wall 100 is moved vertically with respect to the block 2 in the direction of arrow A.

In the illustrated embodiment, the side surfaces 118, 120 of the projections 108 have slopes that are less than the slopes of the side surfaces 122, 124. This minimizes the likelihood of block-forming material being retained in the spaces between adjacent projections as the block 2 is being removed from the mold cavity. In an alternative embodiment, the side surfaces 118, 120, 122, 124 of each projection 108 can be oriented at the same angle with respect to the interior surface of the wall.

In particular embodiments, the diagonal rows of projections 106 extend at angles less than or greater than 45 degrees with respect to the upper and lower edges of the mold wall. As shown in FIG. 3, the rows extending upwardly left to right, such as row 126 form an angle θ with respect to the upper edge of the wall, and the rows extending upwardly right to left, such as row 128, form an angle ω with respect the upper edge of the wall wherein the angle ω is different than the angle θ. Consequently, the crests 110 of the projections 106 are not vertically aligned from the upper edge to the lower edge of the wall. Advantageously, this provides for a more consistent surface texture on the face of a block.

In an exemplary embodiment, the rows extending upwardly left to right, such as row 126, are oriented at an angle θ of about 60 degrees with respect to the wall upper edge, and the rows extending upwardly right to left, such as row 128, form an angle ω of about 30 degrees with respect the wall upper edge. In an alternative embodiment, the angles ω and θ are 45 degrees, in which case crests 110 of the projections are vertically aligned from the upper edge to the lower edge of the wall, as disclosed in U.S. Pat. No. 7,100,886, which is incorporated herein by reference.

As shown in FIGS. 3 and 5, the bottom edge of the mold wall 100 can include a horizontally extending lip, or screed, 130 that extends lengthwise of the wall between the vertical side edges of the wall. The screed 130 desirably projects inwardly (in a direction into the mold cavity) approximately the same distance as the projections 108. The screed 130 functions to flatten or smooth out any high points on the face of the block as the mold moves vertically relative to the block when the block is removed from the mold.

In the embodiment of FIGS. 3-5, the wall 100, the projections 108, and the bars 110, 112 are of a unitary, monolithic construction. The wall 100 may be formed by machining the projections 108 and the bars 110, 112 into one surface of a piece material used to form the mold wall.

In one specific implementation, the projections 108 are machined in a piece of material (e.g., steel) to a depth of about ¼ inch. The width of each projection is about 0.87 inch at their respective bases 114 and about 0.19 inch at their respective end surfaces 116. Of course, these specific dimensions (as well as other dimensions provided in the present specification) are given to illustrate the invention and not to limit it. The dimensions provided herein can be modified as needed in different applications or situations.

In other embodiments, the projections 108 and/or the vertical bars 110, 112 may be separately formed and then coupled or otherwise mounted to the mold wall, such as by welding or with conventional releasable fasteners (e.g., bolts). If releasable fasteners are used, the bar and/or the projections can be removed and replaced with new components when the existing components become worn or otherwise deviate from desired tolerances.

For forming the second face 6 of the block 2, the mold can have a wall similar to wall 100, except having two offset roughening surfaces with projections 108 separated by a bar 110.

FIGS. 6-8 show a mold 200, according to one embodiment, that can be used to form up to five blocks 2a, 2b, 2c, 2d, 2e in a single cycle. Each block in the mold can have different face configurations as shown. Block 2e has the same face configurations on its first and second faces 4, 6 as block 2 of FIGS. 1 and 2. Alternatively, the mold can be configured to form five identical blocks.

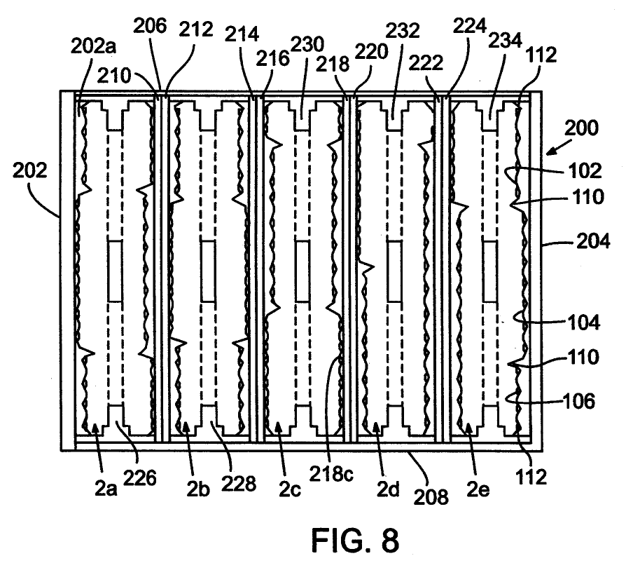

As best shown in FIG. 8, the mold 200 can include end walls 202, 204, side walls 206, 208 extending between respective ends of the end walls 202, 204, and a plurality of internal walls, or dividing plates, 210, 212, 214, 216, 218, 220, 222, 224 extending between the side walls 206, 208 to form a plurality of separate mold cavities 226, 228, 230, 232, 234 (FIG. 6). Each mold cavity in the illustrated configuration has an open upper end 236 through which block-forming material can be introduced into the cavity and an open lower end 238 through which a formed block 2 in an uncured state can be removed, or stripped, from the cavity. The mold 200 can be supported on any suitable support surface, such as a pallet 242 illustrated schematically in FIGS. 6 and 7.

The mold 200 may be adapted for use with any conventional block-forming machine, such as those available from Columbia Machine (Vancouver, Wash.), Masa-USA, LLC (Green Bay, Wis.), Knauer Engineering (Germany), Besser, Inc. (Alpena, Mich.), Tiger Machine (Japan), or Hess Machinery (Ontario, Canada), to name a few.

A substantially horizontally disposed shoe, or plate, 240 (commonly referred to as a “mold head”) may be provided above each mold cavity to facilitate compression of the block-forming material during the block forming process and removal of the formed, uncured blocks 2a-2e from the mold cavities. The shoes 240, each of which is shaped so as to be able to fit slidably within a respective mold cavity, is operable for movement between a raised position above the mold 200 (FIG. 6) and a lowered position within the mold cavities for compressing the block-forming material and for removing the formed, uncured blocks from the mold cavities (FIG. 7). The shoes 240 may be coupled to any suitable mechanism for moving them between the raised and lowered positions and for pressing them against the top surfaces of the blocks 2a-2e. For example, the shoes 240 may be coupled to a hydraulic ram, as generally known in the art.

Forms or core bars (not shown) for forming the cores 16, 18 and the channel 20 in each block can be inserted into the mold cavities. The forms can be supported by bars (not shown) that extend transversely across the open top of the mold 200 and are supported by the side walls 206, 208 of the mold, as known in the art.

The shape of the mold cavities define the plan shape and size of the blocks (i.e., the shape and size of the block when viewed from above or below), with the vertical walls of the mold forming the vertical surfaces (the first and second faces 4, 6 and side surfaces 12, 14) of the blocks. The bottom and top surfaces 10, 8 of the blocks can be formed by the upper surface of the pallet 242 and the lower surfaces of the shoes 240, respectively.

The end walls 202, 204, and the internal walls 210-224, each have interior roughening surfaces configured to texture adjacent surfaces of the uncured blocks 2a-2e as they are removed from their respective mold cavities. As can be seen in FIG. 8, however, several variations are possible to provide different surface configurations on the blocks. For example, end wall 204 has a similar configuration to mold wall 100 shown in FIGS. 3-5 and has first, second, and third roughening surfaces 102, 104, and 106, respectively, separated by vertically extending bars 110 to produce surface portions 22, 24, and 26 on the first face 4 of block 2e. Each of the remaining walls of the mold has roughening surfaces with projections configured to form the desired pattern on the adjacent surface of a corresponding block. For example, mold wall 224 has two offset roughening surfaces to form surface portions 32, 34 of the second face 6 of block 2e.

Each mold cavity in the configuration shown has a generally rectangular plan shape to provide a block having the same general geometric shape. However, the shape of each mold cavity can be varied to provide blocks having other geometrical plan shapes. For example, one or more of the walls defining a mold cavity can be configured to intersect an adjacent wall at an angle that is greater than or less than 90 degrees. In addition, one or more of the walls of a mold cavity may be curved or rounded. Alternatively, a wall may comprise plural segments interconnected to each other at angles. Moreover, a mold cavity may have greater than or less than four vertical walls.

Although each mold cavity of the illustrated mold 200 is shown as having two walls for texturing opposed surfaces of each block, in other embodiments, only one such wall may be used for each mold cavity, or alternatively, two adjacent such walls may be used, or more than two walls for texturing the surfaces of a block may be used. For example, selected portions of the side walls 206, 208 can have projections for texturing one or both side surfaces 12, 14 of one or more of the blocks.

In the illustrated embodiment, as shown in FIG. 6, the internal walls 210, 212 are placed back-to-back and the projections thereon extend into respective mold cavities 226, 228. Similarly, internal wall 214 is placed back-to-back with internal wall 216; internal wall 218 is placed back-to-back with internal wall 220; and internal wall 222 is placed back-to-back with internal wall 224. In an alternative embodiment, a single internal wall formed with projections 108 on both sides (if both sides of the uncured blocks are to be textured by projections) can be used to separate or divide the mold cavities. If only one face 4, 6 of each block in the mold is to be textured by projections, then only one of the walls forming each mold cavity need be provided with projections 108. For example, to form blocks wherein only one face 4, 6 is provided with a roughened surface portion, internal walls 212, 216, 220, 224 can be removed and internal walls 210, 222 can be provided with flat surfaces without any projections on either side.

In still other embodiments, any of the walls 202, 204, 210, 212, 214, 216, 218, 220, 222, 224 can be used as “inserts” for an existing mold wall. For example, an insert having the same configuration as end wall 202 can be placed in the mold cavity 226 against the inner surface of an existing end wall of the mold. When used in this manner, the inserts can be secured to the interior surfaces of existing walls of a mold using suitable techniques or mechanisms, such as using bolts or by welding the inserts in place.

Explaining the operation of the mold, according to one specific approach, and referring initially to FIG. 6, the mold 200 and the pallet 242 can be moved into place under the shoes 240, such as by way of a conveyor (not shown), so that each shoe is aligned over a respective mold cavity. The mold 200 is then loaded with a flowable, composite cementitious fill material through the open top of the mold. Composite fill material generally comprises, for example, aggregate material (e.g., gravel or stone chippings), sand, cement, and water, as generally known in the art. The fill material also may comprise other ingredients, such as pigments, plasticizers, and other fill materials, depending upon the particular application. Other flowable, block-forming materials can be used if forming blocks from non-cementitious materials, and in particular, any granular, flowable material that can form a green-state (uncured) block that is free-standing or self-supporting when stripped from a mold (the green-state block retains its shaped when stripped from the mold).

The mold 200, or the pallet 242, or a combination of both may be vibrated for suitable period of time to assist in the loading of the mold 200 with fill material. The shoes 242 are then lowered into the mold cavities 226, 228, 230, 232, 234, against the top of the mass of fill material in each cavity. The shoes 242 desirably are sized so as to provide a slight clearance with the projections 108 when lowered into the mold cavities. Additional vibration, together with the pressure exerted by the shoes acts to density the fill material and form the final shape of the blocks 2a-2e.

After the blocks are formed, the formed, uncured blocks are removed from the mold such as by raising the mold 200 (as indicated by arrow A in FIG. 7), while maintaining the vertical position of the shoes 240 and the pallet 242 so that the blocks are pushed through the bottom openings 238 of the mold cavities. As the mold moves upwardly relative to the uncured blocks, the projections 108 pass upwardly through the uncured concrete as the concrete flows around the projections. Alternatively, the blocks can be pushed through the mold cavities by moving the shoes 240 through the mold cavities, while simultaneously lowering the pallet and maintaining the vertical position of the mold 200. In either case, the action of stripping the blocks from the mold 200 creates a roughened texture on the adjacent surfaces of the blocks that contact the projections 108.

For example, the projections 108 of the first, second, and third roughening surfaces 102, 104, 106 of the mold wall 204 contact surface portions 26, 24, and 22 (FIG. 1), respectively, of an adjacent block face 4 and create roughened textures on those surface portions. The face 4 of the block is therefore formed with roughened surface portions 22, 24, 26 separated by recessed portions 28, thereby resembling the faces of three blocks arranged side-by-side with each other and laterally offset, or non-co-planar, with respect to each other (FIGS. 1 and 2). As best shown in FIG. 1, due to the offset of the projections, the first and third surface portions 22, 26 are recessed slightly relative to the second surface portion 24. When stacked in courses with like blocks 10, the offset between the surface positions provides a staggered and shadowed appearance akin to a natural stone wall.

Advantageously, unlike some prior art devices, the mold does not require concrete fill material to be retained on the inner surfaces of the mold walls for the purpose of creating roughened surfaces on the block. As such, the mold does not require frequent stoppages in production to clear material from the walls of the mold. Other techniques also can be used to minimize the retention of concrete on the inner surfaces of the mold, for example, a concrete release agent can be applied to the inner surfaces of the mold, wire brushes can be mounted to shoes 240 and positioned to sweep or brush the inner surfaces of the mold walls as the blocks are stripped from the mold, and/or compressed gas nozzles can be positioned to directed compressed gas (e.g., compressed air) against the inner surfaces of the mold after the blocks are removed from the mold to blow away excess concrete from the inner surfaces of the mold.

Because the amount of fill material, if any, retained on projections 108 is minimal, the blocks produced by the mold can maintain their dimensional tolerances through multiple cycles. Thus, in the illustrated example, the roughened surfaces 22, 24, 26 of the block 2e are substantially perpendicular to the top and bottom of the block.

The mold filling time, the vibration times and the amount of pressure exerted by the shoes 240 are determined by the particular block-forming machine being used, and the particular application. After the blocks are removed from the mold 200, they may be transported to a suitable curing station, where they can be cured using any suitable curing technique, such as, air curing, autoclaving, steam curing, or mist curing.

FIGS. 9 and 10 show another example of a block, indicated generally at 300, having offset surface portions. The block 300 has first and second faces 302 and 304, respectively. The first face 302 has a first surface portion 306 that is offset outwardly from a second surface portion 308 with the surface portions being separated by a vertically extending notch 310. Similarly, the second face 304 has a first surface portion 312 that is offset outwardly from a second surface portion 314 with the surface portions being separated by a vertically extending notch 310. Each face 302, 304 can be formed with angled side edges 316 on opposite sides of each face.

Each surface portion of faces 302, 304 can be formed with a roughened surface texture as described above. Further, unlike the block 2 shown FIGS. 1 and 2, the exposed surfaces of notches 310 and side edges 316 can each be formed with a roughened surface texture similar to surface portions 306, 308, 312, and 314. The block 300 otherwise can have a construction similar to the block 2 of FIGS. 1 and 2.

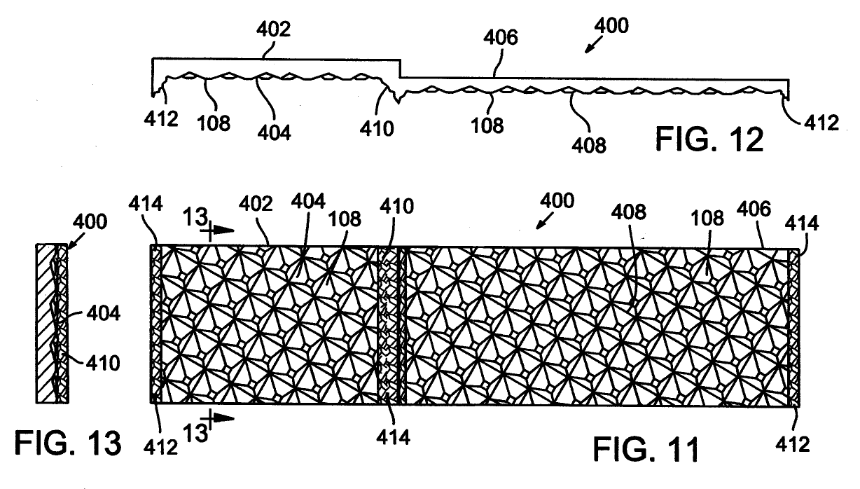

Turning to FIGS. 10-12, there is shown a mold wall 400 that is configured to form a face 302, 304 of block 300. The block 300 can be formed in a mold comprising two such mold walls 400 for forming the opposing faces 302, 304 of the block. As shown, the mold wall 400 comprises a first wall portion 402 defining a first roughening surface 404 and a second wall portion 406 defining a second roughening surface 408 separated by a V-shaped, vertically extending bar or projection 410. Each wall portion 402, 406 has a plurality of projections 108 extending therefrom for contacting an adjacent surface portion of a block (not shown) in the mold. The mold wall 400 can further include V-shaped, vertically extending bars or projections 412 at the opposite sides of the wall. As shown, the projections 108 of the second wall portion 406 are offset inwardly relative to the projections 108 of the first wall portion 402 to form offset surface portions 306, 308 of the block 300. The intermediate bar 410 forms the notch 310 while the outer bars 412 form the side edges 316 of the face of the block. To texture the surfaces of notch 310 and edges 316 of the block, the bars 410, 412 can be provided with a plurality of projections 414, similar to projections 108, that extend into the mold and contact the surfaces of the notch 310 and edges 316. As the uncured block is removed from the mold, the projections 414 create a roughened surface texture on the surfaces of the notch 310 and edges 316. The bars 410, 412 can have a construction similar to core bars formed with multiple projections for texturing the surface of notches or cores in a block, as described in detail in U.S. patent application Ser. No. 11/825,485 (U.S. Publication No. 2008/0174049).

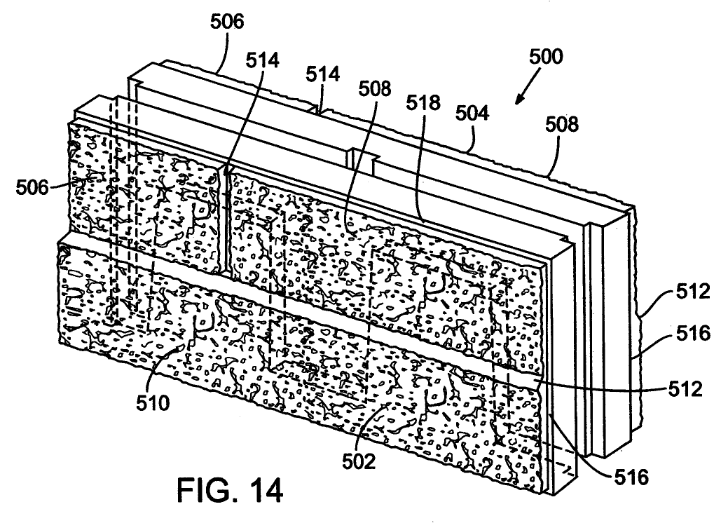

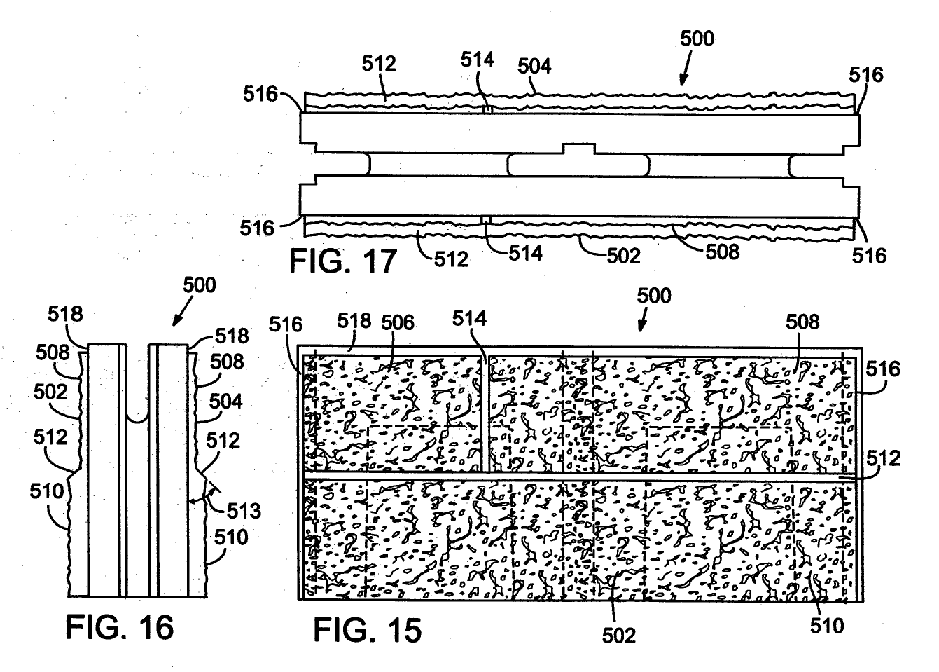

FIGS. 14-17 show another example of a block, indicated generally at 500, having offset surface portions. The block 500 has first and second faces 502 and 504, respectively. The upper half of the first face 502 comprises a first surface portion 506 positioned next to a second surface portion 508. The lower half of the first face 502 comprises a third surface portion 510 that is offset outwardly from the first and second surface portions 506, 508. In the illustrated embodiment, the first and second surface portions 506, 508 are co-planar (non-offset from each other), however, in other embodiments, the first and second surfaces 506, 508 can be offset from each other as described above. The third surface portion 510 is connected to the first and second surface portions 506, 508 by a horizontally extending, non-roughened angled surface 512. In certain embodiments, the surface 512 is oriented at an angle 513 of about 12 degrees to about 20 degrees from the vertical plane, with 15 degrees being a specific example. The first and second surface portions 506, 508 are separated by a vertically extending recessed portion, or notch, 514. Similarly, the second face 508 has respective first, second, and third surface portions 506, 508, and 510, respectively, an angled surface 512 connecting the third surface portion and the first and second surface portions, and a vertically extending recessed portion, or notch, 514 separating the first and second surface portions.

Each face 502, 504 also can be formed with recessed portions, or notches, 516 extending between the top and bottom surfaces on each side of the respective face, and a recessed portion, or notch, 518 extending between the side surfaces adjacent the top surface. When constructing a wall with multiple blocks 500, the abutting notches 516 at the juncture of two adjacent blocks in the same course separate surface portions of one block from the surface portions of the adjacent block. Similarly, the notch 518 of a first block in wall separates and extends between the surface portions 506, 508 of the first block from the surface portion 510 of a second block stacked directly on top of the first block.

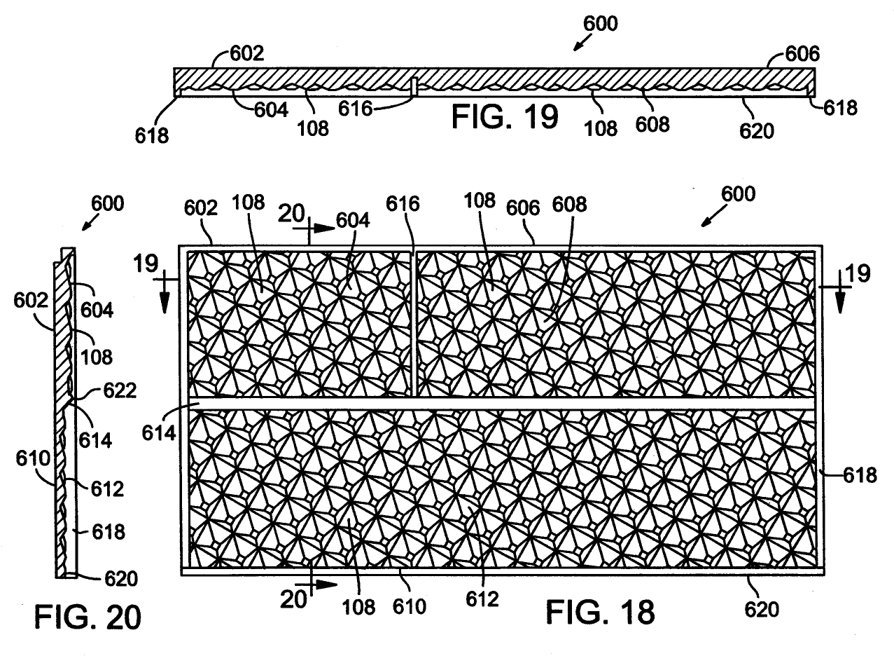

Turning to FIGS. 18-20, there is shown a mold wall 600 that is configured to form a face 502, 504 of block 500. The block 500 can be formed in a mold comprising two such mold walls 600 for forming the opposing faces 502, 504 of the block. As shown, the mold wall 600 comprises a first wall portion 602 defining a first roughening surface 604, a second wall portion 606 defining a second roughening surface 608, and a third wall portion 610 defining a third roughening surface 612. Each roughening surface 604, 608, and 612 has a plurality of projections 108 for forming the first surface portion 506, the second surface 508, and the third surface portion 510, respectively.

The third roughening surface 612 is connected to the first and second roughening surfaces 604, 608, respectively, by a horizontally extending angled surface 614 that forms the angled surface 512 in the face of the block. As best shown in FIG. 20, the projections 108 of the first and second roughening surfaces 604, 608 are offset inwardly (into the mold) relative to the projections of the third roughening surface 612 so as to form the offset configuration of the third surface portion 510 of the block face relative to the first and second surface portions 506, 508. The first and second roughening surfaces 604, 608 are separated by a bar 616 that extends vertically on the face of the wall from its upper edge to the angled surface 614. The bar 616 forms the notch 514 in the face of the block. The mold wall 600 can further include vertically extending bars, or projections, 618 on opposite sides of the wall for forming the notches 516 in the face of the block.

The mold wall 600 can also have a horizontally extending lip, or screed, 620 at its bottom edge to flatten or smooth any high points on the third surface portion 510 on the block face. In addition, as best shown in FIG. 20, the angled surface 614 has a tip 622 that extends lengthwise of the mold wall and projects inwardly approximately the same distance as the projections 108 of the first and second roughening surfaces 604, 608. The tip 622 functions as a screed to flatten or smooth out any high points on the surface portions 506, 508 of the block face as the block is removed from the mold.

The block 500 can be formed in the manner described above by filling the mold cavity with block-forming material and removing the uncured block from the mold. Because the projections 108 of the first and second roughening surfaces 604, 608 extend into the mold cavity a greater distance than the projections 108 of the third roughening surface 612, the block 500 can be stripped from the mold without the projections of the third roughening surface contacting the angled surface 512 formed in the face of the block, thus preserving the angled surface 512 as the block is removed from the mold.

In an alternative embodiment, the first and second surface portions 506, 508 can be separated from each other by a non-recessed, non-roughened surface portion that is co-planar or substantially co-planar with the surface portions 506, 508. The non-roughened surface portion extends vertically between the surface portions 506, 508 similar to notch 514 to provide the appearance of a joint between the surface portions 506, 508. The non-roughened surface portion can be formed by a vertically extending, flat surface portion of the mold wall separating two sets of projections that form roughened surface portions 506, 508. Moreover, the elongated surface portion separating any two roughened surface portions on a block face can have a substantially flat, smooth texture or can be formed to have any other surface texture that contrasts with the texture of the two roughened surface portions of the block to provide the appearance of a joint between those surface portions.

In another embodiment, a block can have two offset, textured surface portions that are positioned side-by-side on a face of the block (such as block 2 of FIG. 1). Instead of a recessed notch separating the two surface portions, the block face can be formed with a flat, non-roughened surface portion extending vertically between and connecting the offset surface portions (similar to surface 512 of FIG. 14). The block can be formed by a mold having two sets of projections, with one set being offset from the other set to form the offset between the surface portions on the block face. The flat surface portion separating the two offset surface portions on the block face can be formed by a vertically extending, flat surface portion on the inside surface of a mold that extends between the two sets of projections (similar to surface 614 of FIG. 18).

In another embodiment, the first and second surface portions 506, 508 can be separated from the third surface portion 510 by a horizontally extending notch in the face of the block. The notch can be formed by a horizontal core bar that is removed from the mold before the uncured block is removed from the mold, as described in detail in U.S. patent application Ser. No. 11/285,485.

Finally, the embodiments of blocks disclosed herein have two surfaces that are provided with textured surface portions. However, this is not a requirement. The apparatuses and methods disclosed herein can be used to form a block having only one face that is provided with textured surface portions, as may be the case for making blocks for retaining walls.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. I therefore claim as my invention all that comes within the scope and spirit of these claims.

I claim:

1. An apparatus for molding and forming a roughened surface texture on at least one face of an uncured masonry block, comprising:
a mold defining at least one mold cavity, a first opening through which block-forming material is introduced into the mold cavity, and a second opening through which a formed, uncured block may be removed from the mold cavity;
wherein the mold further comprises at least one wall having a plurality of projections extending into the mold cavity and contacting an adjacent face of the uncured block, such that when the uncured block is removed from the mold cavity, the projections create a roughened surface texture on at least a first surface portion and a second surface portion of the adjacent face; and
wherein the at least one wall is configured to form the first and second surface portions such that the first surface portion is offset relative to the second surface portion in a direction perpendicular to the adjacent face.

2. The apparatus of claim 1, wherein the first surface portion and the second surface portion are separated by a recessed surface portion in the adjacent face.

3. The apparatus of claim 2, wherein the recessed surface portion in the adjacent surface is created by an elongated bar extending from the at least one wall.

4. The apparatus of claim 1, wherein the first surface portion and the second surface portion are positioned side-by-side with respect to each other in the adjacent face.

5. The apparatus of claim 1, wherein the first surface portion is positioned above the second surface portion in the adjacent face.

6. The apparatus of claim 1, wherein the at least one wall is configured to form a third surface portion in the adjacent face that has a roughened surface texture and is offset relative to at least one of the first surface portion or the second surface portion in a direction perpendicular to the adjacent face.

7. The apparatus of claim 1, wherein the projections are arranged in rows on the inside of the at least one wall.

8. The apparatus of claim 1, wherein the at least one wall comprises first and second wall portions each having projections thereon, the projections of the first wall portion extending into the mold cavity a greater distance than the projections of the second wall portion, the first wall portion being configured to create a roughened surface on the first surface portion of the block, the second wall portion being configured to create a roughened surface on the second surface portion of the block.

9. The apparatus of claim 3, wherein the bar includes projections adapted to create a roughened surface texture on the recessed surface portion.

10. The apparatus of claim 3, wherein the bar has a generally V-shaped cross-section.

11. The apparatus of claim 1, wherein the projections are positioned side-by-side in multiple rows of projections, each projection having a respective base that adjoins a base of an adjacent projection in the same row, the rows of projections extending diagonally across the at least one wall of the mold so as to define diagonally extending grooves between adjacent rows of projections.

12. A method for forming a masonry block, comprising:
introducing block-forming material into a mold cavity of a mold, the mold having a plurality of projections extending into the mold cavity and located between the top and bottom of the mold cavity;
forming an uncured block in the mold cavity, the uncured block having a surface which is adjacent to the plurality of projections and comprising at least a first surface portion and a second surface portion; and
removing the uncured block from the mold cavity to move the projections across the first surface portion and the second surface portion so as to give a roughened appearance to the first surface portion and the second surface portion;
wherein the second surface portion is offset relative to the first surface portion in a direction perpendicular to the adjacent surface.

13. The method of claim 12, wherein the first surface portion and the second surface portion are positioned side-by-side with respect to each other.

14. The method of claim 12, wherein the first surface portion is positioned above the second surface portion.

15. The method of claim 12, wherein the first surface portion and the second surface portion are separated by a recessed surface portion in the adjacent surface.

16. The method of claim 12, wherein the adjacent surface further comprises a third surface portion that is offset from at least the first surface portion or the second surface portion, and wherein removing the uncured block from the mold cavity causes the projections to move across the third surface portion so as to give a roughened appearance to the third surface portion.

17. The method of claim 12, wherein each of the plurality of projections are generally frusto-pyramidal in shape.

18. A masonry block formed by a method comprising:
introducing block forming material into a mold defining at least one mold cavity including a first opening through which the block-forming material is introduced into the mold cavity, and a second opening through which the uncured block may be removed from the mold cavity, the mold having a plurality of projections extending into the mold cavity;
forming an uncured block in the mold cavity, the uncured block having a surface which is adjacent to the plurality of projections and comprising at least a first surface portion and a second surface portion that are non-coplanar with respect to each other; and
removing the uncured block from the mold cavity to move the projections across the first surface portion and the second surface portions to create a roughened surface texture on each of the first and second surface portions.

19. The uncured masonry block of claim 18, wherein the first surface portion has a first width and the second portion has a second width that is greater than the first width.
